(19) United States
(12) Patent Application Publication
(10) Pub. No.: US 2009/0147936 A1
(43) Pub. Date: Jun. 11, 2009

(54) FRAMEWORK FOR COUNTERING VoIP SPAM

(75) Inventors: You-jae Won, Yongin-si (KR); Young-duk Cho, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: Korea Information Security Agency

(21) Appl. No.: 11/956,774

(22) Filed: Dec. 14, 2007

(30) Foreign Application Priority Data
Dec. 5, 2007 (KR) 10-2007-0125670

(51) Int. Cl. H04M 3/42; H04M 3/436

(52) U.S. Cl. 379/201.02; 379/210.02

(57) ABSTRACT

Framework for countering VoIP SPAM. The framework is applicable to all sessions sending out the spam from an outbound domain to a inbound domain, in which the outbound domain and the inbound domain respectively has: a spam prevention system for detecting whether an outbound call is spam and blocking the call if needed; a spam prevention policy server for adding, modifying, or deleting spam countering policies being applied to the spam prevention system; and a call server for making or receiving a call, in connection with the spam prevention system.

### CROSS-REFERENCE TO RELATED APPLICATION

This application claims all benefits of Korean Patent Application No. 10-2007-0125670 filed on Dec. 5, 2007 in the Korean Intellectual Property Office, the disclosures of which are incorporated herein by reference.

### BACKGROUND OF THE INVENTION

1. Field of the Invention

The present invention generally relates to a framework for countering VoIP spam; and, more particularly, to a framework for countering VoIP spam capable of effectively blocking spam in real time, by utilizing a spam prevention system provided to each domain and sharing spam information.

2. Description of the Prior Art

VoIP spam means unsolicited calls or IM/SMS messages sent (or received) to (or from) a VoIP terminal, or transmitted over a VoIP communications channel.

Depending on the spam content, VoIP spam can largely be categorized into SPIT (SPam over Internet Telephony) and SPIM (SPam over Instant Messaging).

SPIT is a spam call that is transmitted after a phone call is answered by a callee (called party).

SPIT is a spam in the form of a text message, which is carried in a signal message for call connection and displayed to a callee before he (she) answers a phone call. In case of SPIM, a spammer can avoid a telephone charge by intercepting a call before a callee accepts the call.

In addition, depending on the spam transmission method, VoIP spam can be categorized into two types: VoIP spam sent by a normal call procedure and VoIP spam sent directly to a callee terminal. The former is the same as a call delivery procedure in general between a caller and a callee. Meanwhile, the latter transmits, provided that a caller knows address and telephone number of a callee, spams can be transmitted to a callee terminal by adopting a P2P system which connects a call directly.

VoIP spam differs from face-to-face spam transmission from telemarketers in that it is sent via a shared Internet line which already exists, while phone spam or cell phone spam is sent via an occupied telephone line, so transmission costs of the VoIP spam are relatively low.

Also, similar to phone spam, cell phone spam, or e-mail spam, VoIP spam is sent out to many and unspecified persons with the aid of a recorder or other means. Especially, P2P-based spam or SPIM may be transmitted at no telephone charge to the provider.

Among traditional approaches for countering spam, particularly e-mail spam, which is text based spam, can be blocked through content filtering before a recipient receives the spam.

In case of VoIP spam, however, it is hard to get benefits from content filtering because, by nature of telephone service, people receive spam calls from many and unspecified persons. As e-mail spam is anonymous, VoIP spammers can disguise their identities, revealing weakness of the protocol itself.

Still, there is another problem that real-time tracing of spammers is practically impossible because VoIP spam can be transmitted over any Internet accessible environment and because a logical address such as an IP address is not sufficient to find a geopolitical location.

### SUMMARY OF THE INVENTION

It is, therefore, an object of the present invention to provide a framework for countering VoIP spam effectively for detecting and blocking a spam attack which has emerged as a major threat for VoIP service environment where people expect to get low telephone charges and a variety of additional services.

Another object of the present invention is to provide a framework for countering VoIP spam capable of detecting and blocking spams in real time, and distributing spam blocking costs by individual sessions.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

In accordance with an aspect of the present invention, there is provided a VoIP spam countering framework applicable to all sessions sending out the spam from an outbound domain to a inbound domain, in which the outbound domain and the inbound domain respectively includes: a spam prevention system for detecting whether an outbound call is spam and blocking the call if needed; a spam prevention policy server for adding, modifying, or deleting spam countering policies being applied to the spam prevention system; and a call server for making or receiving a call, in connection with the spam prevention system.

The VoIP spam countering framework may further include a DNS server for registration and management of the call server sending a valid call.

The VoIP spam countering framework may further include a intermediate domain including at least one call server, which receives a call sent from the call server of the outbound domain, inquires whether the call server is registered to the DNS server, and selectively delivers the call to the inbound domain, depending on a response from the DNS server.

The VoIP spam countering framework may further include an information sharing center for managing spam information, wherein the information sharing center includes: a spam report reception center for receiving VoIP spam information transmitted from the spam prevention policy server of the inbound domain; and an RBL management server for combining a realtime black list (RBL) inputted from the spam report reception center and the spam prevention system, and redistributing RBL information updated according to a spam policy to the spam prevention system.

The spam prevention system of the outbound domain filters a call transmitted from UAC by using one of prefix code filtering, SIP URI filtering, SPIM filtering and grey list based filtering.

The grey list based filtering classifies state of a caller into an unknown state, a grey state, and a black state, by deciding a SPIT level by combining information on a count of the number of call recipients, call duration, call traffic, call rejection rate, call rate, and inter-call time.

Preferably, the call server is constituted of a proxy server or a registrar server.

The call server of the inbound domain includes: an invite message processing function, which receives an invite message from the outbound domain and which parses a Via header of the invite message to extract information on the outbound domain; an SPF (Sender Policy Framework) module, which sends an SPF inquiry about the outbound domain information being extracted by the invite message processing function and a caller address and which processes an SPF response message received from the DNS server; and a virtual spam blocking module, which records SPF results being processed in the SPF module in a log file format.

The framework for countering VoIP spam of the present invention ensures that spam countering costs are not entirely charged to a inbound domain, and effectively prevents VoIP spam attacks originated from diverse scenarios.

Moreover, the framework for countering VoIP spam of the present invention features an excellent spam blocking function through an easy and simple procedure without going through a filtering process on contents of real-time services.

### BRIEF DESCRIPTION OF THE DRAWINGS

FIG. 1 is a block diagram showing the configuration of a framework for countering VoIP spam and an operation thereof, according to one embodiment of the present invention

FIG. 2 shows a caller authentication procedure according to one embodiment of the present invention.

FIG. 3 shows a state transition diagram of a SPIT level decision model.

FIG. 4 describes definitions of a SPIT level decision model.

FIG. 5 shows a source route authentication procedure according to a preferred embodiment of the present invention.

FIG. 6 shows an example of SPF record being issued.

FIG. 7 shows an example of an invite message.

### DETAILED DESCRIPTION OF THE EXEMPLARY EMBODIMENTS

The present invention is directed to a framework comprising the concept and procedure of a spam countering technique specialized for a VoIP service environment, specific techniques thereof and the like.

In detail, a framework for countering VoIP spam comprises specific countering techniques that can be applied correspondingly to sources, routes, and inbound domains, taking a call delivery route into consideration, and defines necessary functions and domain-specific logics that are added to counter a spam according to VoIP service configuration system such as a terminal, a call server, etc.

Examples of specific techniques for call delivery sessions include prefix filtering and blacklist filtering for both outbound domains and inbound domains, keyword filtering, volume-based filtering, and outbound domain authentication that is applied to intermediate domains. A host performing these functions is configured with a terminal, a spam prevention system and a spam prevention policy server.

Preferred embodiments of a framework for countering VoIP spam of the present invention will now be described with reference to the accompanying drawings.

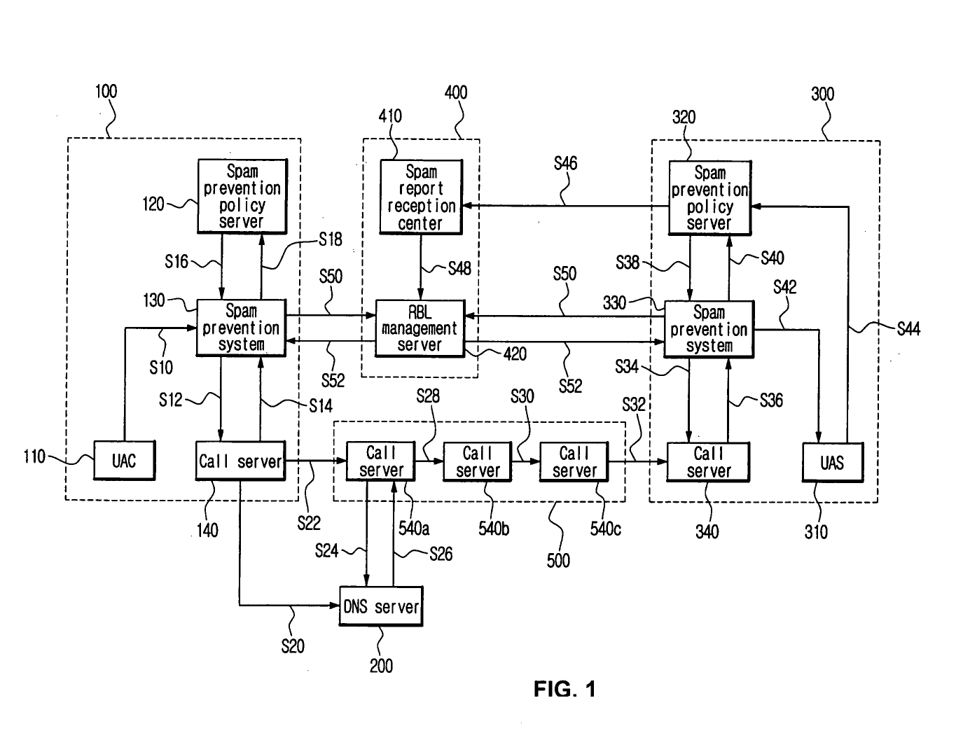

FIG. 1 is a block diagram showing the configuration of a framework for countering VoIP spam and how the framework is operated, according to one embodiment of the present invention.

As shown in FIG. 1, the framework for countering VoIP spam of the present invention includes an outbound domain 100, a inbound domain 300, and an information sharing center 400. Optionally, it further includes a DNS (domain name system) server 200 and a intermediate domain 500.

The outbound domain 100 includes a spam prevention policy server 120, a spam prevention system 130, and a call server 140. Likewise, the inbound domain 300 includes a spam prevention policy server 320, a spam prevention system 330, and a call server 340.

UAC (user agent client) 110 is a host responsible for VoIP spam transmission. It may be a VoIP terminal such as a softphone or an H/W phone, or software having a spam generation function. In order to reduce errors (e.g., an error detection rate and a detection failure rate), it is desired to configure the UAC 110 to be able to identify a fact that the UAC 110 turned out to be a spammer or an outbound call of interest is blocked.

The spam prevention systems 130, 330 detect whether an outbound call is a spam and blocks the call if it is. In addition, the spam prevention systems 130, 330 receive a spam countering policy from the spam prevention policy servers 120, 320 on a regular basis, and forward any log having been blocked according to a given policy to the spam prevention policy servers 120, 320.

The spam prevention policy servers 120, 320 add, modify, or delete spam countering policies to be applied to the spam prevention systems 130, 330, to periodically provide them to the spam prevention systems 130, 330 (S16, S38).

The call servers 140, 340 constitute the outbound domain 100 and the inbound domain 300, respectively, and either make outbound calls or receive inbound calls, incorporating with the spam prevention systems 130, 330.

In particular, the call server 140 of the outbound domain 100 is registered to the DNS server 200 before starting a service, provided that the call server 140 is a valid server not involved in spam transmission.

The call server 340 of the inbound domain 300 checks whether an inbound call has received via a valid route, and accepts the call if it has.

The call servers 140, 340 may be proxy servers or registrar servers for example.

The DNS server 200 does not send spam, but manages registration of the call server 140 making a valid outbound call.

The UAS (user agent server) 310 is a VoIP terminal such as a softphone or an H/W phone, and may become a host that receives VoIP spam. Thus, the UAS is a target to which all possible countermeasures for preventing reception of spam over VoIP and for handling a received spam are applied.

The framework for countering VoIP spam may further includes a intermediate domain 500, the intermediate medium for making or receiving a call, between the outbound domain 100 and the inbound domain 300. In detail, the intermediate domain 500 receives a call originated from the call server 140 of the outbound domain 100 and queries whether the outbound domain the call is originated from is registered to the DNS server 200. The intermediate domain 500 includes one or more call servers 540a, 540b, 540c, which selectively deliver the call to the inbound domain 300 according to a response from the DNS server 200.

The framework for countering VoIP spam may further includes the information sharing center 400 constituted of a spam report reception center 410 and an RBL (realtime block list) management server 420.

The content of a spam report, which is forwarded from a recipient terminal to the spam prevention policy server 320 of the inbound domain 300, is transferred to the spam report reception center 410 by the spam prevention policy server 320 to be utilized for intra-domain spam countering policies.

The RBL management server 420 combines a black list being inputted in realtime by the spam report reception center 410 and the spam prevention systems 130, 330, to redistribute updated RBL information based on a given spam policy to the spam prevention systems 130, 330.

The following will now describe the procedure for countering VoIP spam, with reference to FIG. 1.

When the UAC 110 transmits a call (S10, S12) through the call server 140, authentication of a caller and a source route is carried out, according to the HTTP digest user authentication process. To prevent outbound spam, the spam prevention system 130 filters a call from the UAC 110 by employing at least one of prefix code filtering, SIP URI filtering, SPIM filtering, and grey list based filtering. The filtering process will be explained in detail later on.

Next, only a call having gone through the filtering is delivered to the call server 340 of the inbound domain 300, or to the call server 540a of the intermediate domain 500 (S22). As aforementioned, the call server 140 of the outbound domain 100 is defined, before the service is started, in a DNS SPF field as a valid call outbound domain and registered to the DNS server 200 (S20).

Meanwhile, if the call turned out to be a spam as a result of the filtering process, the spam prevention system 130 blocks the corresponding outbound call and provides a result of the blocking to the spam prevention policy server 120 (S18).

Then, the call server 540a of the intermediate domain 500 queries whether the outbound domain which made the outbound call of interest is registered to the DNS server 200 (S24), and receives its result (S26). If ‘fail’ is received as a response, the call server 540a of the intermediate domain 500 intercepts the call delivery; if ‘pass’ is received as a response, the call server 540a delivers the call via a normal route (S28, S30).

Next, the call servers 540a, 540b, 540c of the intermediate domain 500 forwards the call to the call server 340 of the inbound domain 300 (S32), and the call is then sent to the spam prevention system 330 (S36). The spam prevention system 330 detects a dictionary attack and spam against an inbound call through prefix code filtering, SIP URI filtering, or SPIM filtering, etc.

If the call turned out to be spam as a result of the filtering process, the spam prevention system 330 blocks the corresponding call (S34) and provides a result of the blocking to the spam prevention policy server 320 (S40).

However, if the filtering result indicates that the call is not spam, the corresponding call is forwarded to the UAS 310 (S42). Here, a recipient spam countering policy is applied to the call delivery from the spam prevention system 330 to the UAS 310 to examine whether it corresponds to a receive mode and a user blacklist set by a recipient. If it does not conflict with the recipient spam countering policy, the call is sent to the UAS 310. Otherwise, the call is blocked before connected.

Meanwhile, if the call which the UAS 310 had received finally turned out to be spam, the user (i.e., the recipient) makes a spam report to the spam prevention policy server 320, so that it can be reflected to the spam countering policy through feedback (S44).

Spam report information provided to the spam prevention policy server 320 through the spam prevention system 330 and the UAS 310 is transferred to the spam report reception center 410 (S46).

The RBL management server 420 combines, in entire domains, the information from the spam report reception center 410 and realtime blacklists of each one of domains (S48, S50), and redistributes the combined information to respective domains (S52).

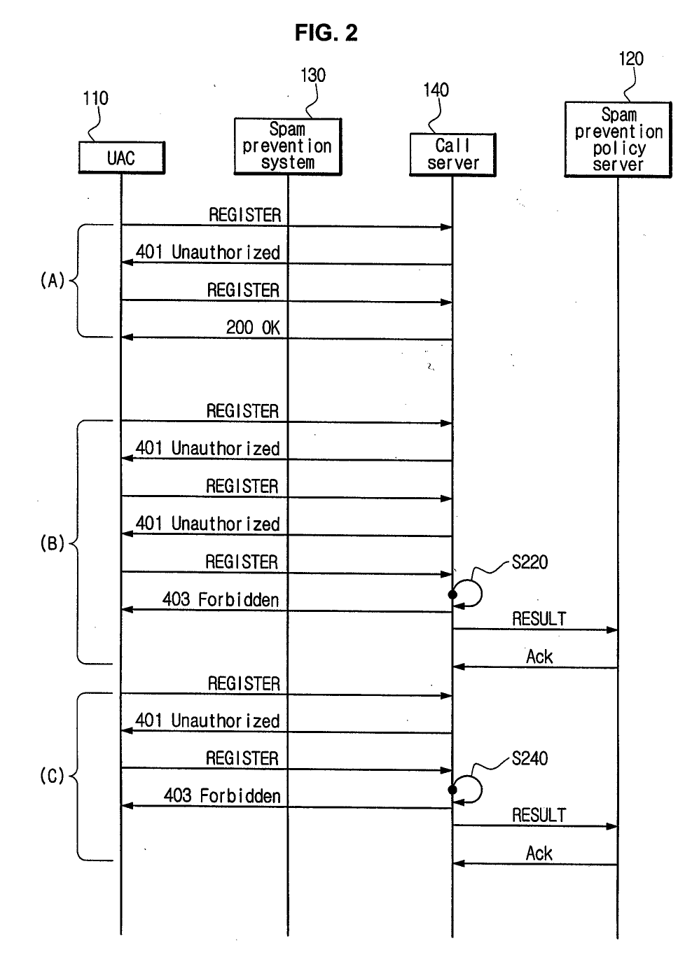

FIG. 2 shows a caller authentication procedure according to one embodiment of the present invention.

Referring to FIG. 2, service authority of a user is verified in accordance with RFC3261. To this end, user authentication policy is applied to block dictionary attacks, replay attacks, and SQL injection attacks.

(A) Section shows a procedure where a caller is successfully registered, by applying HTTP Digest authentication mechanism to RFC3261.

(B) Section shows a procedure for inhibiting a spammer, who had taken a valid ID of the user by illegally sniffing a register message, from attempting to guess a password through a dictionary attack. If making REGISTER attempts to a call server exceeds 3 times (S220), further attempts are forbidden (403 Forbidden) and this incidence is informed to a spammer. Later, the spam prevention policy server 120 receives its result.

(C) Section shows a procedure for blocking a replay attack and an SQL injection attack besides the dictionary attack. The replay attack results in a spammer sniffing a register msg and attempting authentication by using it again. This attack is much more likely to succeed if authentication parameters like nonce were not changed but have easily predictable values. The SQL injection attack results in a spammer illegally sniffing a register msg to attempt to attack a user's ID and password field, and manipulating a user registration DB.

Once the replay attack or the SQL injection attack is detected (S240), further attempts are forbidden (403 Forbidden) and this incidence is informed to a spammer. Later, the spam prevention policy server 120 receives its result.

The following will now explain a filtering process at the spam prevention system 130.

The spam prevention system 130 processes a call by prefix code filtering, only if a specific code exists in an invite message received from the UAC 110. That is to say, it checks whether or not SIP URI of a caller has a predetermined specific code to proceed with a filtering process. Also, it may change a prefix code value for each one of domains by using an environment setup file.

The prefix coding between the UAC 110 and the spam prevention system 130 is made possible based on an assumption that only a domain-specific UA program can make an outbound call. This is because even though a caller dials from the UAC 110 into a regular SIP URI, by the UA internally, a prefix code value, which is designated transparently to every caller, should be attached to be sent to the spam prevention system 130. In this manner, it becomes possible to prefilter a random call that a spammer creates through an automatic spam generator.

SIP URI filtering is a filtering method complying with the Layer 5 SIP protocol standard, which blocks a specific caller or a specific phone number (i.e., a SIP URI value of the From field) to filter spam.

SPIM filtering filters spam containing a specific advertising keyword that an administrator had registered by inputting keys, so as to block SPIM being transmitted as a text form in the From or Subject field, for example.

Grey list based filtering is a filtering method which categorizes spam levels of callers in accordance with a certain standard, and adds a caller with a SPIT level over a predetermined SPIT reference level to the blacklist. Here, SPIT level is a spam index of individual caller used as a basis of the grey list.

A SPIT level decision model and a SPIT level decision algorithm will now be explained henceforth.

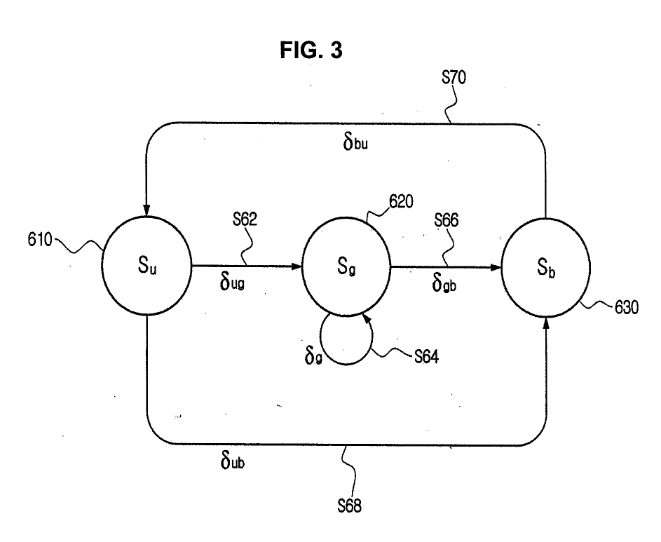

FIG. 3 depicts a state transition diagram of a SPIT level decision model.

Referring to FIG. 3, a SPIT level decision model is largely categorized into three states. Each one tells the state of a caller. For example, Sᵤ (Unknown state) 610 is a state where it is hard to designate a SPIT level, S_{g} (Grey state) 620 is a state resulted from a change in particular attribute values, and S_{b} (Black state) 630 is a state where a caller is categorized as an absolute spammer. The information on these three states is utilized as definition or criteria to decide which class a caller belongs to. This SPIT level decision model is represented in terms of a function responsible for state transition among the states.

In the Sᵤ state 610, only static attributes have meanings and ‘0’ is assigned as the SPIT level. For instance, a caller ID, payment, an authentication method, etc., which are part of the static attributes, are examined in order to suspect SPIT.

The S_{g} state 620 expresses the number of call recipients, call duration, call traffic, call rate, and call rejection rate in terms of a value between 0 and 9, indicating a spam index or a SPIT level. These attributes are involved with the state transition (S62) from Sᵤ 610 to S_{g} 620, and affects an increase in the SPIT level (S64).

The S_{b} state 630 is a state where the SPIT level becomes ‘10’ (S66). Any call in this state is absolutely treated as spam. This is a case when all information about a caller clearly points out the caller as a spammer to be added to the blacklist.

According to the SPIT level decision model, once a caller is classified into the S_{g} 620, he (she) is targeted for management continuously henceforth. In addition, a caller in the S_{b} state 630 also cannot transit to the S_{g} state 620. As an exception, however, the state transition may occur by an input from a user or with a lapse of time. If there is a request from outside, asking to transit a particular caller from S_{b} 630 to Sᵤ 610, such a request is also regarded as an exception and the state transition is permitted (S70).

Moreover, the state transition (S68) from Sᵤ 610 to S_{b} 630 is another exception that can be done at user's request. Therefore, states and state transition are managed so that any possible disorder or error in near future may be prevented through explicit definitions of a caller's state transition.

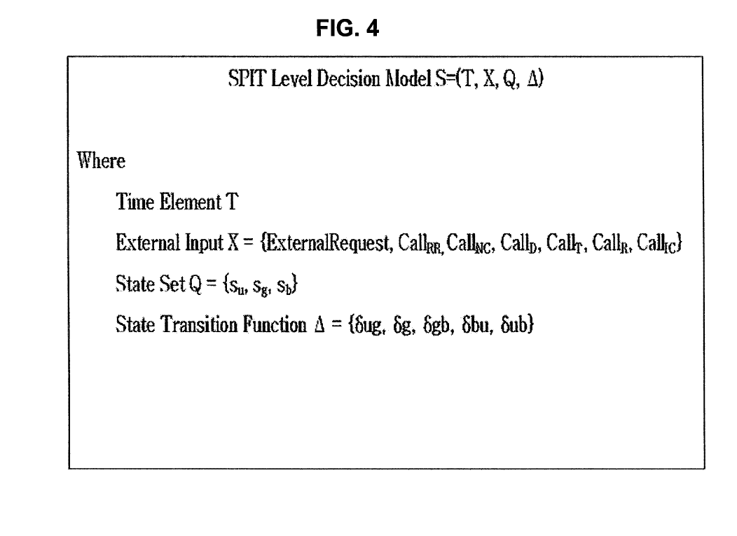

FIG. 4 describes definitions of a SPIT level decision model.

Referring to FIG. 4, the SPIT level decision model is constituted of T which shows a time attribute, X which defines a set of external inputs, Q which defines a set of states, and A which is a set of state transition functions. The time attribute T is for defining a change in state that can occur after the lapse of a certain time.

The external input X is divided into 7 kinds as shown in the following Table 1. Among them, six items except for an external request are information used as a reference for deciding whether a given call is spam, and they influence the state transition or a SPIT level change in the grey state. An initial external request input is a state change request made by a user or an algorithm from outside. This input is an exceptional condition that causes a state transition without going through the grey state.

TABLE 1

| Input X | Description |
|---|---|
| External request | Administrator and external program |
| | request |
| Call_{RR} | Call Rejection Rate |
| Call_{NC} | Number of Call Recipients |
| Call_{D} | Call Duration |
| Call_{T} | Call Traffic |
| Call_{R} | Call Rate |
| Call_{IC} | Inter-Call Time |

The call rejection rate and the inter-call time are inputs that affect the state transition from Sᵤ 610 to S_{g} 620, and from S_{g} 620 to S_{b} 630, respectively. They are also functions calculating an internal SPIT level in S_{g} 620 for update. If a SPIT level is between 1 and 9, update is continued but the state change does not occur because of that. This is because the state of this model simply sets a reference value of a present state, and the grey state, according to the definition of this model, is set when the SPIT level is between 1 and 9.

FIG. 3 illustrates a situation, in which if the state transition from S_{b} 630 to Sᵤ 610, the state of a caller on the black list changes to an unknown state after the lapse of a certain time. When caller related information is provided by inputs of the state transition functions, each one of the state transition functions is used to decide a SPIT level according to a given algorithm.

The SPIT level decision algorithm will now be described. SPIT level decision elements are based on data obtained through simulation. Six major data analyzed meaningfully in the simulation are information obtained by making or receiving calls. Characteristics of these data are analyzed to derive an algorithm for deciding a SPIT level.

Table 2 below classified characteristics of data, depending on whether a spammer is capable of manipulating data and whether it can be definite evidence of the spam. This classification is for deciding the importance or value of those six pieces of information mentioned earlier.

TABLE 2

| | |
|---|---|
| Spammer is | Spammer is |
| capable | incapable of |
| of manipulating | manipulating |
| data | data |

| | | | | |
|---|---|---|---|---|
| Less valuable | A1 | Call_{R} | B1 | Call_{RR} |
| as the symptom | | Call_{IC} | | |
| of spam | | | | |
| Highly valuable | A2 | Call_{T} | B2 | Call_{NC} |
| as the symptom | | | | Call_{D} |
| of spam | | | | |

As apparent from the Table 2, for example, the lowest value is given to A1, namely, if a spammer is able to manipulate data and low in weight as the symptom of spam, followed by B1, A2, and B2 in increasing order of the value for decision of a SPIT level for all types of data. The reason why A2 has higher priority than B1 is because although A2 data can be manipulated, a spammer practically hardly takes call traffic into account while generating a spam call. There is little difference in priority in each type, that is, between call rate and inter-call time, and between number of call recipients and call duration.

In particular, since the call rate is an index for calculating the number of inbound calls per unit hour, it has a direct correlation with the inter-call time. In other words, the higher the call rate, the shorter the inter-call time.

Moreover, the number of call recipients and the call duration of B2 in the Table 2 are the most crucial elements to identify a spammer.

When these two pieces of information are utilized together, one can say that most information necessary to detect a spammer are obtained. By incorporating the rest of the information, the possibility to verify the spammer becomes much higher.

This approach to increase conviction through data collection can be likened to the evidence accumulation process in knowledge processing technologies, which collects evidence by deduction. Here, data classification and verification through practical application of a system are necessary to decide the weight of evidence.

The following Table 3 explains attributes of the six pieces of information mentioned above.

TABLE 3

| | Attributes | Description |
|---|---|---|
| Individual | Number of | It derives an index based on |
| call attribute | call | information about each call |
| is considered | recipients | recipient. |
| | Call | It derives an index using a call |
| | duration | duration value for every call. |
| | Call | It derives an index in consideration |
| | traffic | of average transmission traffic of |
| | | every call. |
| Characteristics | Call | It indicates a ratio of rejected |
| (statistics) | rejection | calls to all calls from a |
| of inter-calls | rate | corresponding caller. |
| are considered | Call rate | It indicates a count of calls from a |
| | | corresponding caller per unit hour. |
| | Inter-call | It indicates an inter-call time from |
| | time | a corresponding caller per unit hour. |

When all designated information necessary to make a decision on spam as an administrator wanted are collected, each information item is then analyzed to see if it is related to spam. By using derived values, one can decide whether a caller of interest is a spammer. Even though a weight value of each one of indexes determines an initial value through an index classification scheme, a system for managing spammers according to class should be provided with an environment where the system is capable of modifying and managing the weight value at the same time.

Attributes that are necessary to decide a SPIT level should be derived as a quantitative value to meet the need. Especially, it is required to properly normalize the derived values from all of the indexes to reflect them on the SPIT level. The following Table 4 shows formulas for indexes, weight values, and their ranges. All indexes are set to have a value between 0 and 1. Moreover, the weight values are randomly set up for illustrative purposes only, so they also can be changed.

TABLE 4

| | | | Weight |
|---|---|---|---|
| | | | (initial |
| Index | How to calculate | Range | value) |
| Number of call | Number of call | [0 . . . 1] | 50% |
| recipients | recipients/Number | | |
| | of connected calls | | |
| Call duration | Number of connected | [0 . . . 1] | 30% |
| | calls/Number of | | |
| | calls lasting longer | | |
| | than a time limit to | | |
| | regard a call as an | | |
| | ordinary one | | |
| Call traffic | Number of suspected | [0 . . . 1] | 10% |
| | spam calls/Number of | | |
| | total calls (provided | | |
| | that a present average | | |
| | traffic is 110% or | | |
| | above) | | |
| Call rejection | Calculate a call | [0 . . . 1] | 5% |
| rate | rejection rate and | | |
| | normalize it by | | |
| | utilizing the | | |
| | distribution of | | |
| | existing data. | | |
| Inter-call time | Calculate an inter- | [0 . . . 1] | 3% |
| | call time and | | |
| | normalize it by | | |
| | utilizing the | | |
| | distribution of | | |
| | existing data. | | |
| Call rate | Calculate a call rate | [0 . . . 1] | 2% |
| | and normalize it by | | |
| | utilizing the | | |
| | distribution of | | |
| | existing data. | | |

In case characteristics of the inter-call relationship (statistics) are to be used (e.g., call rejection rate, call rate, inter-call time), a normal distribution is configured based on the mean/standard deviation for each data and a position of current data is calculated.

The other three indexes, namely, a count of the number of call recipients, call duration and call traffic (excluding the call rejection rate, the call rate, and the inter-call time) are calculated complying with the procedures described in the Table 4. Then, a normal distribution is configured to see characteristics of data and provided through UI.

Once necessary attributes for SPIT level decision are determined, it is required to determine a situation where each one of the attributes becomes abnormal state. To this end, a threshold is needed for every index. Adjustment of threshold is the real and essential standard for making a decision whether to include a caller of interest to the blacklist.

The following will now explain the SPIT level decision algorithm. To be brief, attributes of all indexes are normalized and combined to decide a SPIT level. In order to normalize attributes of all indexes, certain numbers are used. However, it should be noted that those numbers are for illustrative purposes only, so the present invention is not limited thereto.

Among the attributes, a count of the number of call recipients is calculated by collecting information about a hundred recent calls originated from a caller of interest and information about call recipients first. Then, same call recipients are eliminated to count an actual count of the number of call recipients CallRecipient_{NUM}. Finally, the number of call recipients is divided by 100 to obtain a call recipient number rate CallRecipient_{RATE}.

Call duration is calculated by collecting information about a hundred recent calls originated from a caller of interest first. Then, call initiation time is subtracted from call termination time to obtain call duration, and calls that lasted longer than a given call duration threshold are eliminated. Further, the number of calls that lasted for a short amount of time, CallDuration_{Num-Short}, is counted and divided by 100 to compute call duration rate CallDuration_{Rate}.

Call traffic is calculated by collecting information about a hundred recent calls originated from a caller of interest first. Then, call traffic information is extracted, and calls that lasted less than a given call duration threshold are eliminated. Further, the number of calls with a large traffic rate (Byte/Sec), CallTraffic_{Num-High}, is counted and divided by 100 to compute call traffic rate CallTraffic_{Rate}.

Call rejection rate is calculated by collecting information about a hundred recent calls originated from a caller of interest first. Then, call rejection information is extracted and the number of rejections to corresponding caller is counted. Further, mean/standard deviation of a count of rejected calls for all callers, CallRejection_{Mean}/CallRejection_{StdDev}, are calculated to deduce a normal distribution based on them. Finally, a ratio of the number of rejected calls CallRejection_{Num} of the caller of interest is computed from a cumulative normal distribution, so as to obtain a call rejection rate.

Inter-call time is calculated by collecting information about a hundred recent calls originated from a caller of interest first. Then, previous call termination time is subtracted from present call initiation time to obtain an inter-call time, and average of inter-call time for all of the 100 calls is calculated. Further, mean/standard deviation of inter-call time for all callers, InterCallTime_{Mean}/InterCallTime_{StdDev}, are calculated to deduce a normal distribution based on them. Finally, a ratio of the mean inter-call time InterCallTime_{Mean} of the caller of interest is computed from a cumulative normal distribution, so as to obtain an inter-call time rate InterCallTime_{Rate}.

Call rate is calculated by collecting information about a hundred recent calls originated from a caller of interest first. Then, a time domain (or time range) where the 100 recent calls are made from the caller is used for calculating an average call rate CallRate_{AVG}. Further, mean/standard deviation of call rates for all callers, CallRate_{Mean}/CallRate_{StdDev}, are calculated to deduce a normal distribution based on them. Finally, an average call rate CallRate_{AVG} of the caller of interest is computed from a cumulative normal distribution, so as to obtain a call rate.

These aforementioned six indexes are normalized values to express SPIT level. These normalized values represent degrees of contribution to SPIT levels, in use of weight (or weight values) described earlier in Table 4.

$${SPIT\_Level}_{Caller} = α \times {CallRecipient}_{Rate} + β \times {CallDuration}_{Rate} + γ \times {CallTraffic}_{Rate} + δ \times {CallRejection}_{Rate} + ɛ \times {InterCallTime}_{Rate} + ζ \times CallRate \\ ( here , α + β + γ + δ + ɛ + ζ = 100 \% \qquad [ Equation 1 ]$$

In Equation 1, α, β, γ, δ, ε, and ξ respectively represent a degree of contribution or weight to a SPIT level of each index. The sum of these indexes is limited to 100%, and the value of a SPIT level may vary depending on characteristics of these values. Initial value of an every-individual index is listed in Table 4 for example, and those values may be changed to derive an optimum value by an administrator.

If a caller has a SPIT level above a predetermined SPIT reference level, a decision threshold (between 0 and 1) is required to add the caller as a SPIT sender. In case the SPIT level calculated by the Equation 1 exceeds the decision threshold, the corresponding caller is added to the blacklist.

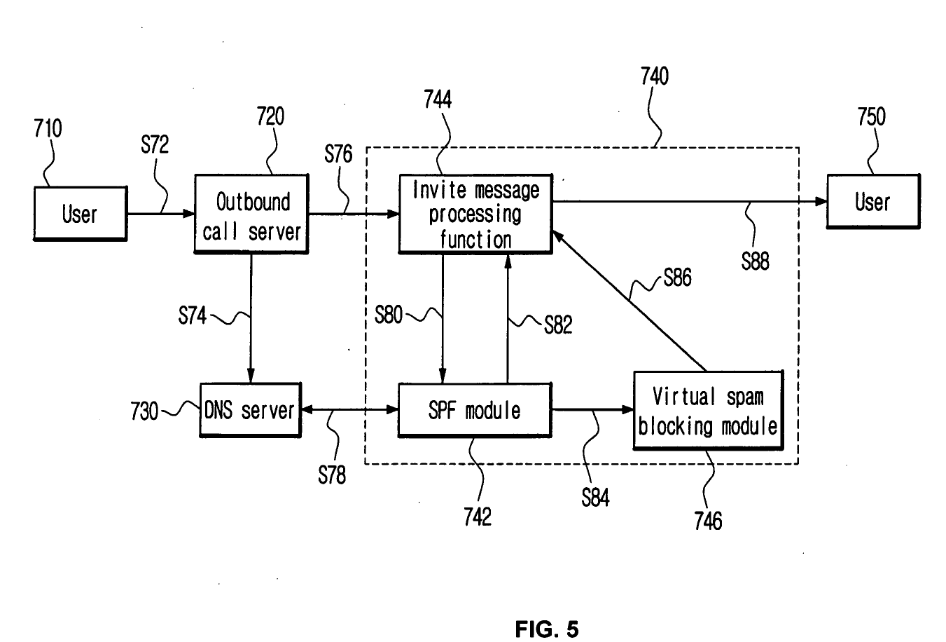

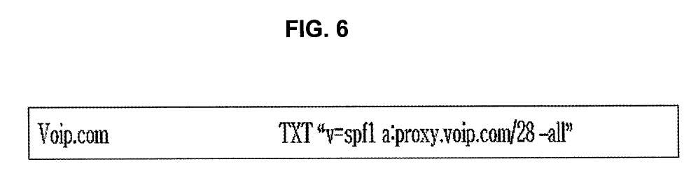

FIG. 5 shows a source route authentication procedure according to a preferred embodiment of the present invention, and FIG. 6 shows an example of SPF record being issued.

VoIP authentication is a valid policy within a single domain only. Because information of an outbound call including caller information can easily be manipulated on an intermediate route, it is important to authenticate the route of an outbound domain. In VoIP service, SPF inquiry/validation processes are carried out in an inbound call server 740.

In FIG. 5, when an outbound call is made from a user 710, the call is sent to an outbound call server 720 (S72), and the outbound call server 720 then issues an SPF record as shown in FIG. 6 to a DNS server 730 (S74).

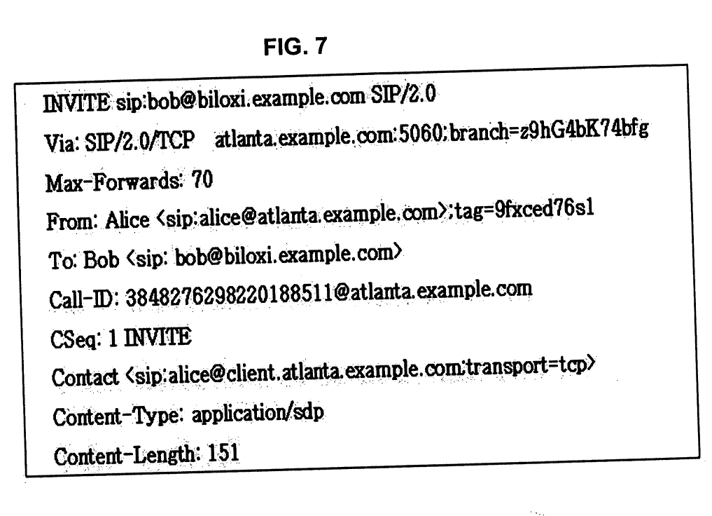

The outbound call server 720 sends an invite message as shown in FIG. 7 to an inbound server 740 (S76), so that an invite message processing function 744 of the inbound call server 740 parses a via header of the invite message to obtain information on the outbound domain. Because the via header is “mandatory” in RFC, the outbound call server 720 always has to insert its domain information to the via header.

Moreover, the inbound call server 740 parses a source IP address of an IP header to obtain the address of the outbound call server.

In order to compare a URI of the parsed invite message with the outbound address, an SPF record on the outbound URI should be obtained from the DNS server 730. Therefore, an inquiry/response on an outbound URI of the invite message is made to the DNS server 730 (S78) to decide whether the outbound call server 720 is a normal call server.

A SPF module (742) sends an SPF inquiry about the outbound domain information being extracted by the invite message processing function (744) and a caller address, and the SPF module (742) processes an SPF response message received from the DNS server (730).

To verify a domain of the outbound call server 720 in a SIP-based SPF, inquiry/verification processes (S80, S82) are carried out, and a result value thereof is used as a basis to decide whether to process the invite message. However, in other cases except for ‘pass’ (S84), it is better to process a call combinedly with other spam blocking solutions, rather than to block the call directly.

In short, SPF results can be summarized in the following Table 5.

TABLE 5

| Division | Description |
|---|---|
| none | An outbound domain has not issued an SPF |
| | record, or an SPF verification device |
| | cannot judge whether the outbound domain is |
| | forged because it could not obtain |
| | information of a domain of interest out of |
| | the provided caller information. |
| neutral | Do not want to judge whether a call sent |
| | from the outbound call server is forged. A |
| | call being judged as “neutral” is processed |
| | equally to a call being judged as “none”, |
| | and this option is used in SPF test |
| | operations or the like. |
| pass | Regard a received message as legal, and |
| | forwards the message to the next hop. |
| fail | Regard a received message as illegal, and |
| | combines the message with another spam |
| | blocking solution, instead of forwarding it |
| | to the next hop. |
| Temperror | A temporary error in the course of DNS |
| | inquiry. Therefore, DNS inquiry/response |
| | processes are carried out again. |
| Softfail | As done in “fail”, regard the outbound call |
| | server as illegal, and combine a received |
| | call (or message) with another spam |
| | blocking solution. |
| Permerror | A result that occurs when a permanent error |
| | is made in the course of DNS |
| | inquiry/response processes. Do not proceed |
| | with inquiry/verification processes any |
| | more, and combines a received call (or |
| | message) with another spam blocking |
| | solution. |

Unlike the e-mail based SPF, the SIP-based SPF activates a virtual spam blocking solution against all received calls if an invite call being received was not identified as “pass”, instead of processing a SPF result later in header information. The virtual spam blocking module 746 is not for designing a solution for blocking real spam, but simply combining SPF results with another spam blocking solution later, and records the results in a log file format.

Moreover, the virtual spam blocking module 746 transfers a spam response to the invite message processing function 744 (S86), so that a call may be selectively delivered to a user 750 through the invite message processing function 744.

While the present invention has been described with respect to the specific embodiments, it will be apparent to those skilled in the art that various changes and modifications may be made without departing from the spirit and scope of the invention as defined in the following claims.

What is claimed is:

1. A VoIP spam countering framework applicable to all sessions sending out the spam from an outbound domain to a inbound domain, the outbound domain and the inbound domain respectively comprising:
a spam prevention system for detecting whether an outbound call is spam and blocking the call if needed;
a spam prevention policy server for adding, modifying, or deleting spam countering policies being applied to the spam prevention system; and
a call server for making or receiving a call, in connection with the spam prevention system.

2. The framework according to claim 1, further comprising:
a DNS server for registration and management of the call server sending a valid call.

3. The framework according to claim 2, further comprising:
a intermediate domain including at least one call server, which receives a call sent from the call server of the outbound domain, inquires whether the call server is registered to the DNS server, and selectively delivers the call to the inbound domain, depending on a response from the DNS server.

4. The framework according to claim 1, further comprising:
an information sharing center for managing spam information,
wherein the information sharing center includes:
a spam report reception center for receiving VoIP spam information transmitted from the spam prevention policy server of the inbound domain; and
an RBL management server for combining a realtime black list (RBL) inputted from the spam report reception center and the spam prevention system, and redistributing RBL information updated according to a spam policy to the spam prevention system.

5. The framework according to claim 1, wherein spam prevention system of the outbound domain filters a call transmitted from UAC by using one of prefix code filtering, SIP URI filtering, SPIM filtering and grey list based filtering.

6. The framework according to claim 5, wherein the grey list based filtering classifies state of a caller into an unknown state, a grey state, and a black state, by deciding a SPIT level by combining information on a count of the number of call recipients, call duration, call traffic, call rejection rate, call rate, and inter-call time.

7. The framework according to claim 1, wherein the call server is constituted of a proxy server or a registrar server.

8. The framework according to claim 1, wherein the call server of the inbound domain comprises:
an invite message processing function, which receives an invite message from the outbound domain and which parses a Via header of the invite message to extract information on the outbound domain;
a SPF module, which sends an SPF inquiry about the outbound domain information being extracted by the invite message processing function and a caller address and which processes an SPF response message received from the DNS server; and
a virtual spam blocking module, which records SPF results being processed in the SPF module in a log file format.
